(19) United States
(12) Patent Application Publication
(10) Pub. No.: US 2012/0054022 A1
(43) Pub. Date: Mar. 1, 2012

(54) REAL-TIME DISPLAY OF MULTIMEDIA CONTENT IN MOBILE COMMUNICATION DEVICES

(76) Inventor: Yona Kosashvili, Holon (IL)

(21) Appl. No.: 13/318,564

(22) PCT Filed: May 5, 2010
(86) PCT No.: PCT/IL10/00363

§ 371 Date: Nov. 2, 2011

Related U.S. Application Data
(60) Provisional application No. 61/175,861, filed on May 6, 2009.

(51) Int. Cl. G06Q 30/02

(52) U.S. Cl. 705/14.43; 705/14.64; 705/14.41

(57) ABSTRACT

The present invention discloses an application residing on a mobile device for providing and presenting information The application comprises the following components, a detection module for identifying the activation of at least one function of the mobile device, a selection module enabling to choose at least one information object upon activation of the mobile device function according to predefined rules, a display management module for redesigning the display layout to include at least two display areas a first functional area to display functional screen of the identified function and the second informative area for displaying pre-defined information which is not required for the activated function, wherein the redesigning include setting the definitions of each display area, and a GUI module for integrating the display areas into a single presentation, wherein the user is exposed to selected information object through out the time period he is using the activated functionality

### FIELD OF INVENTION

The present invention relates in general to the field of providing commercial information through wireless (cellular. Wi-Fi) network, more particularly it relates to systems and methods for designing and presenting commercial information on a mobile device display.

### BACKGROUND OF THE PRIOR ART

Mobile devices known in the art support a wide range of applications including managing and playing multimedia content (e.g., pictures, tunes, and video), games, third party applications, image capturing by means of a built-in camera, and more. For supporting these applications mobile devices are equipped with wide screens having of high resolutions and enhanced display and audio capabilities

Those improved audio-visual features of modern mobile devices render them attractive as a platform for providing and displaying multimedia content to end users, particularly promotional marketing content (advertisement). There were several attempts for distributing promotional content over mobile communication infrastructures, which however suffered several disadvantages, inter alia:
The commercial content was displayed on dedicated platform, thus requiring users to adapt new usage habits. Based on single task architecture, the display of commercial content interfere users in their daily functional usage of the mobile device, requiring them to stop the current functional task in order to display commercial content (e.g. SMS or pre roll advertising).
The commercial content exposure could not be tracked.
Usually provision of commercial content was available only to users subscribing to advanced services, thus limiting the target audience to a relatively small percentage of the mobile device users.
The commercial content was displayed by using primitive phone capabilities, such as screen saver, background images, wall paper, windows title bar or status bar.

For example, WO 2006/086353 provides a method for conveying visual messages to a user mobile device along with metadata comprising instructions for displaying the message content when the mobile phone is receiving an incoming call and/or ending and incoming call, by replacing the screen saver and wall paper of the mobile device with the message content.

Another method for displaying advertisements in wireless communication devices is described in WO 1999/059283 which suggests displaying advertisements in full screen and by scrolling/fixed text banners, which are displayed on the title bar or directly on the content area of the wireless communication devices.

US 2002/072353 describes a method for displaying advertisements data on displays of mobile communication devices, wherein the advertisement data is displayed on the screen background whenever the device is activated.

### SUMMARY OF INVENTION

The present invention discloses an application mounted on a mobile device for providing and presenting commercial information.

The application comprises: a detection module for identifying the activation of at least one function of the mobile device, a selection module enabling to choose at least one information object upon activation of the device function, according to predefined rules including at least one of the following parameters: a profile of the mobile device user, type of activated functionally, the timing of activation or user preference, a display management module for re-designing the display layout to include at least two display areas: a first functional area to display functional screen of the identified function and the second informative area for displaying pre-defined information which is not required for the activated function, wherein the re-designing include setting the definitions of each display area, said definitions include at least two parameters: the area size and its location and a GUI module for integrating the display areas into a single presentation, wherein the user is exposed to selected information object throughout the time period he is using the activated functionality

The predefined information may include interactive buttons.

According to some embodiments of the present invention application may further comprise the following components: a scheduler module for determining the next information objects to be displayed according to advertisement campaign business rules, an authorization module for verifying if the identified functionality is approved by the user for changing the its design layout according to user profile definitions and or an analysis module for analyzing the behavior pattern of the user according to recorded user log.

The information management module may enable to update the information objects and campaign data from a remote server, wherein the update is preformed according pre-defined schedule or rules.

The information management module may enable to record log of exposure periods of each information object and activation of the interactive buttons, and updating the remote server of said log.

The application may further comprise a business rules module for updating the business rules according to user behavior pattern analysis and received updates of the new campaign data.

According to some embodiments of the present invention the design layout divides the display into two area, wherein the ratio between the areas is determined according to timing, user profile, information object properties,

The present invention provides a method for providing and presenting commercial information on a mobile device, said method comprising the step of; identifying the activation of at least one function of the mobile device, selecting at least one information object upon activation of the device function, according to predefined rules including at least one of the following parameters: a profile of the mobile device user, type of activated functionally, the timing of activation or user preference, re-designing the mobile display layout to include at least two interactive display areas: a first functional area to display functional screen of the identified function and the second informative area for displaying pre-defined information which is not required for the activated function, wherein the re-designing include setting the definitions of each display area, said definitions include at least two parameters the area size and it's location and integrating the display areas into a single presentation, wherein the user is exposed to selected information object throughout the time period he is using the activated functionality.

According to some embodiments of the present invention the method may further comprise the step of updating the information objects by downloading new information objects from a remote server through wireless data network, wherein the update is preformed according pre-defined schedule or rules. According to some embodiments of the present invention the information objects update can be preformed online, utilizing wireless data network communication. Such updated may be relevant for presenting informative content such as news feeds, online dictionary services. Where the informative information may be relevant to user generated content such as messages.

The method may further comprise the following steps: recording user log of his exposure to the information and activities, said log is periodically updated at a remote server through wireless data network, analyzing behavior pattern of the user based on recorded log, scheduling the next information objects to be displayed according to advertisement business/campaign management rules, verifying if the identified functionality is approved by the user for changing the its design layout according to user profile definitions, changing selected information objects during the activation of a specific functionality, in accordance with identified texts and context of content to which the user is exposed at both display areas and/or updating the business rules according to user behavior pattern analysis and received updates of the new campaign data.

The design layout may divide the display into two area, wherein the ratio between the areas is determined according to timing, user profile or information object properties. According to some embodiments of the present invention discloses a system for distributing and presenting commercial information on a mobile device, said system comprising: a server application including campaign management module, and user management module, a client server application including, detection module for identifying new activated function of mobile device, selection module for choosing at least one commercial information objects and layout design module for re-designing display layout including at least two areas: functional area and commercial information area.

The server application updates the device with new campaign information and client application updates the server with user log including exposure time of the commercial information. The selections of commercial information objects and the campaign information business rules are based on pattern analysis of the users' logs.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a schematic illustration of the environment in which the disclosed system and method operate in accordance with embodiments of the present invention;

FIG. 2 is a block diagram of the client application in accordance with embodiments of the present invention;

FIG. 3 is a block diagram of the server application in accordance with embodiments of the present invention;

FIG. 4 is flowchart illustrating the process of re-designing and presenting commercial information in accordance with embodiments of the present invention;

FIG. 5 is flowchart illustrating the process of updating the client and server applications in accordance with additional embodiments of the present invention.

FIG. 6 is flowchart illustrating the process of the server applications in accordance with additional embodiments of the present invention.

FIGS. 7A, 7B and 7C are examples of display design layout in accordance with additional embodiments of the present invention.

FIGS. 8A, 8B and 8C are examples of display design layout in accordance with additional embodiments of the present invention.

FIGS. 9A, 9B and 9C are examples of display design layout in accordance with additional embodiments of the present invention.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a system and a method for a providing and presenting commercial information to mobile device, such as mobile phone, PDA, note books or tablet users. The suggested method enable new presentation platform of displaying advertisements or informational content for a mobile user throughout his normal usage of the mobile device. The new platform is enabled by changing the design layout of the display to include both the functional screens of the mobile device and information objects simultaneously within a single display. Such advertisement does not intervene in the normal course of the mobile device usages.

The information object may include different types of multimedia objects such, text/hypertext, images, audio or video. The information objects may include commercial campaign data constructed from various multimedia contents such as, Short video messages, Image banners, and Commercial company logos. The campaign data may include business rules comprising at least one of the following: Target audience age, Target audience location, Target audience occupation, Window of time to display the advertisement/marketing content, Display time and method of the advertisement/marketing content. According to some embodiments of the present invention the information object may include informative content such as dictionary information, news feeds, user messages, etc.

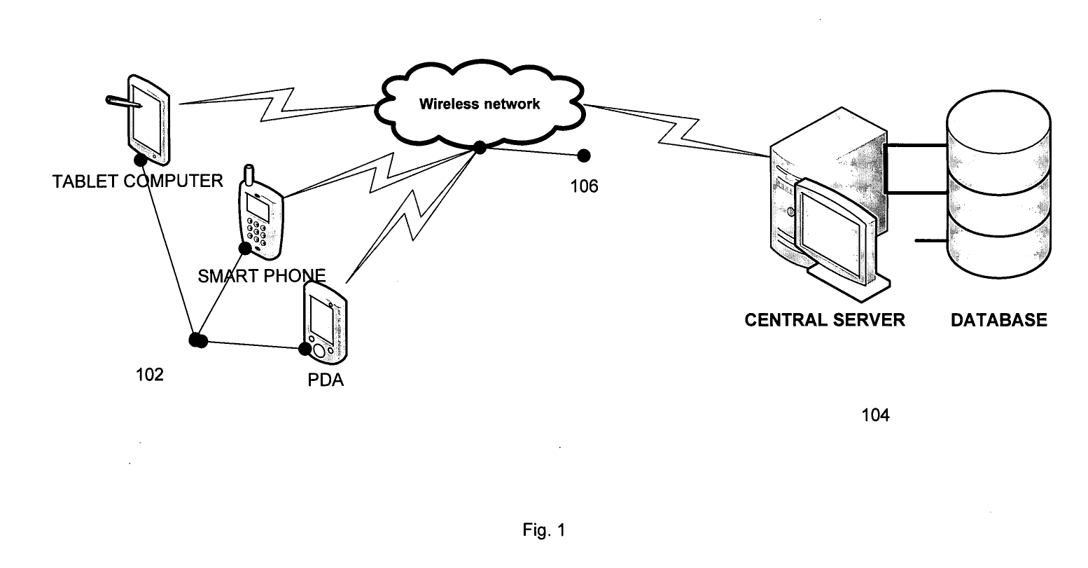

FIG. 1 is a schematic illustration of the environment in which the disclosed system and method operate in accordance with some embodiments of the present invention. A mobile device 102 such as cellular phone, PDA or tablet computer, communicates (the connection is established from time to time only for data transfer between the server and each client) through a wireless data network with a central server 104 and its database. The mobile device includes a client application for activating the presentation platform and managing the commercial information objects, the application is operatively working in association with a server application which provides campaign management platform enabling the distribution of the commercial information to plurality of mobile device through the wireless network.

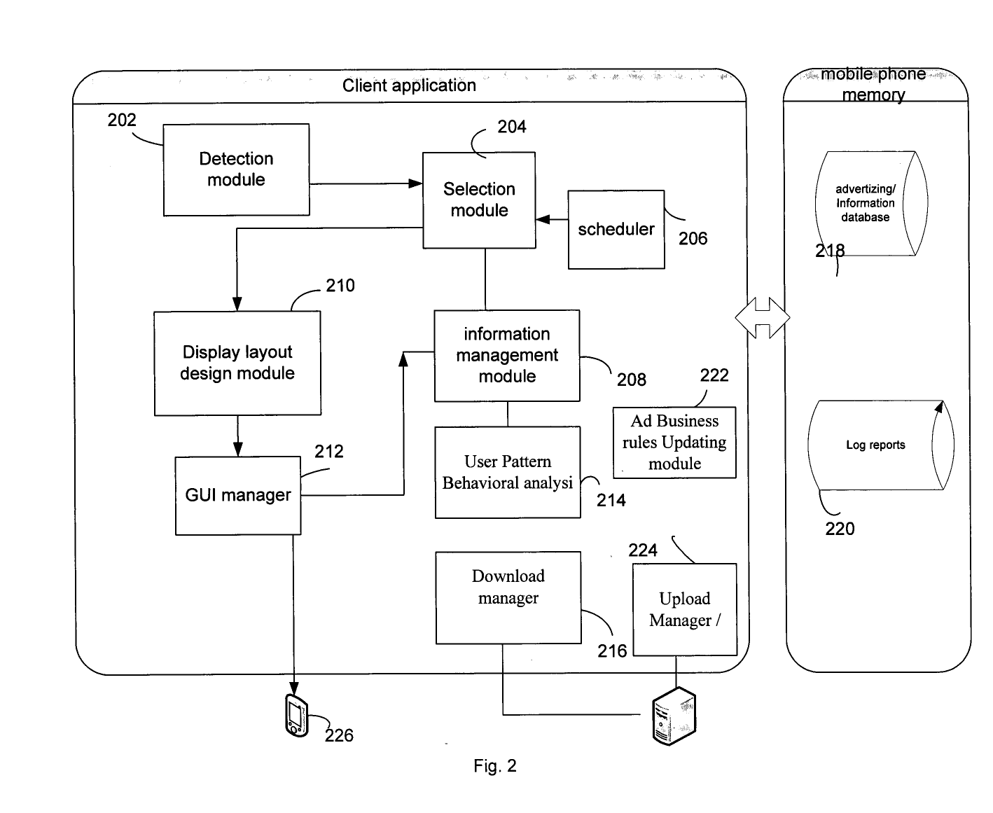

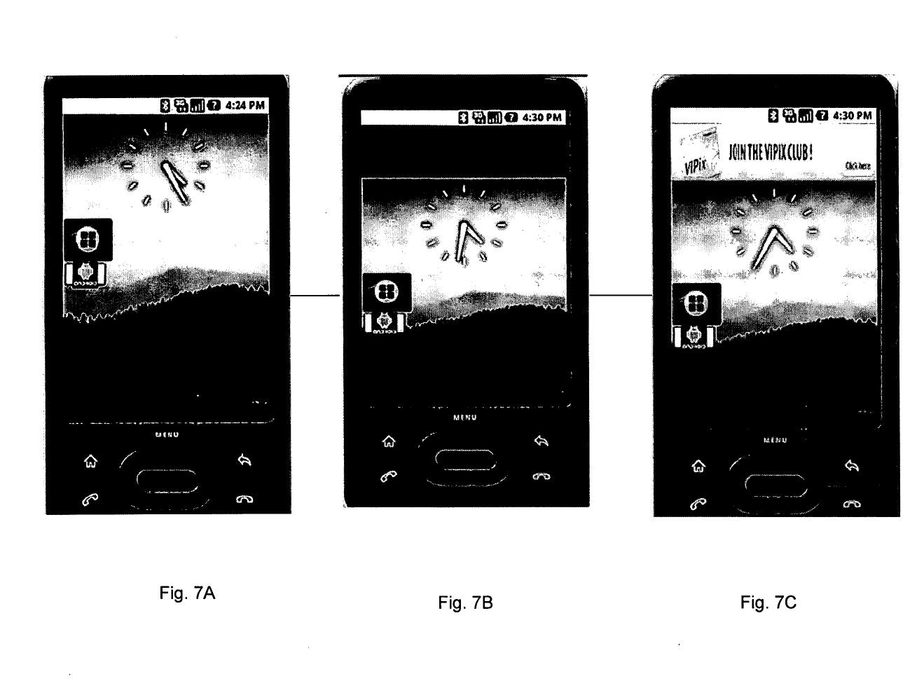

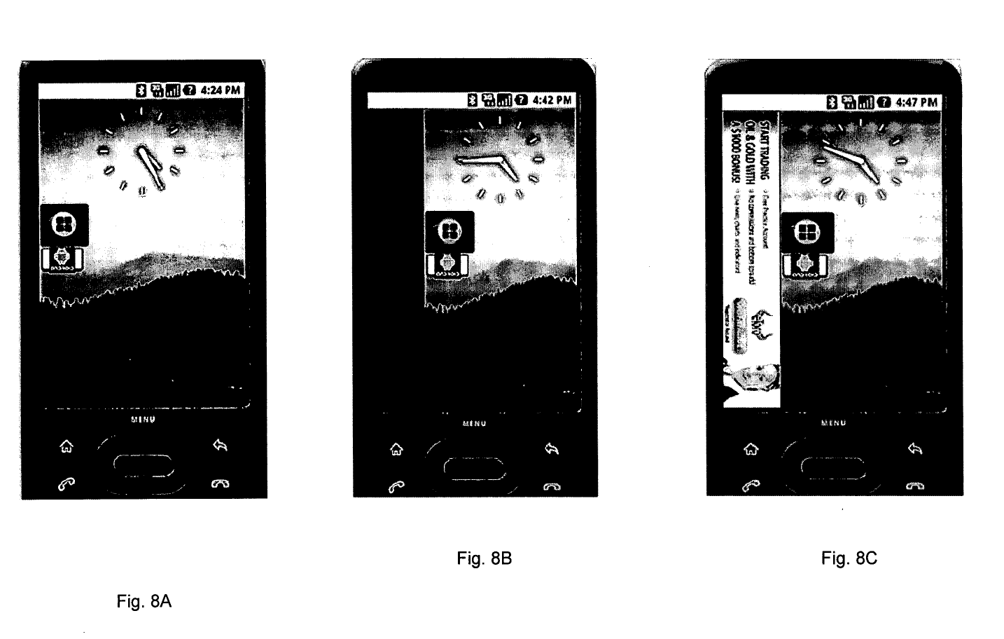

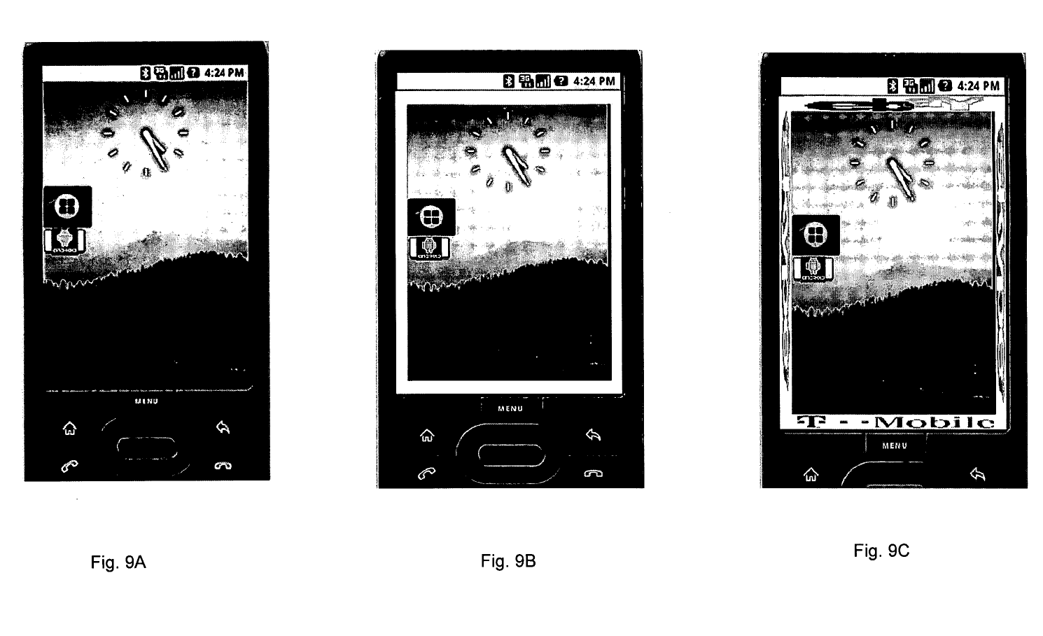

FIG. 2 illustrates a block diagram of the main components of the client application according to some embodiments of the present invention. The detection module 202 intercepts all device activities for identifying new activated actions/function of the mobile device such as new phone call, sending a new message (SMS or mails) incoming/outgoing calls, during reading or writing SMS messages, navigating through menu, during editing, adding or searching for a contact, displaying pictures, playing games, running third side applications, etc. For each activated function, the module verifies authorization to change the display layout design according to user authorization preferences. For verified functions the selection module 204 chooses the proper information object according to user profile, analysis of user behavior pattern, and input of scheduler 206 for timing the commercial information according to the business rules which define priority between information objects and context depended rule. The display layout design module 210, retrieves a template design layout associated with the identified function, input the selected commercial information object into the template and making the adjustments to the selected information objects to fit the design layout, if required (e.g. changing the size or resolution of an information object). The design layout may include at least two display areas, a first display area for the functional screen of the identified action and second display for presenting the selected information object. The design layout module may change the ratio between the two displayed area according to predefined rules relating to user profile, timing or properties of the selected information object. According to some embodiments of the invention the design layout divides the mobile device display into two areas: vertically as seen in FIG. 7C or horizontally as seen in FIG. 8C. Optionally the design layout can define the first area as center portion of the display screen and the second area as surroundings area portion see FIG. 9. According to other embodiment of the present invention the information object may include interactive buttons, enabling the user to navigate to other information objects or react to the information objects (e.g. answering a survey, phone call, SMS, go online). The two display areas are integrated into a single screen presentation, by the GUI module 212 including the functional screen of the activated function and commercial information. The information management module 208 enables to track the exposure time period of the user to the selected information objects and usage of interactive actions, creating and recording a user log. The user log is conveyed to the server using the upload manger 224. The pattern analysis module 214 receives user log, and analyses user behavior for updating user profile and the business rules by the Business rules Updating module 222, which provide more effective matching of the information objects the user. The mobile device memory includes user log records 220 as recorded by the information management module, and commercial information repository 218 which is updated by the download manager 216. According to further embodiments of the present invention, the commercial objects appearing at the second display area can be updated during the session of an active functionality, such as a phone call. The update can be triggered according to timing, after predefined time period or according to defined business rules by identifying changes of data or events in user activities, such as message text, or the context of visited sites.

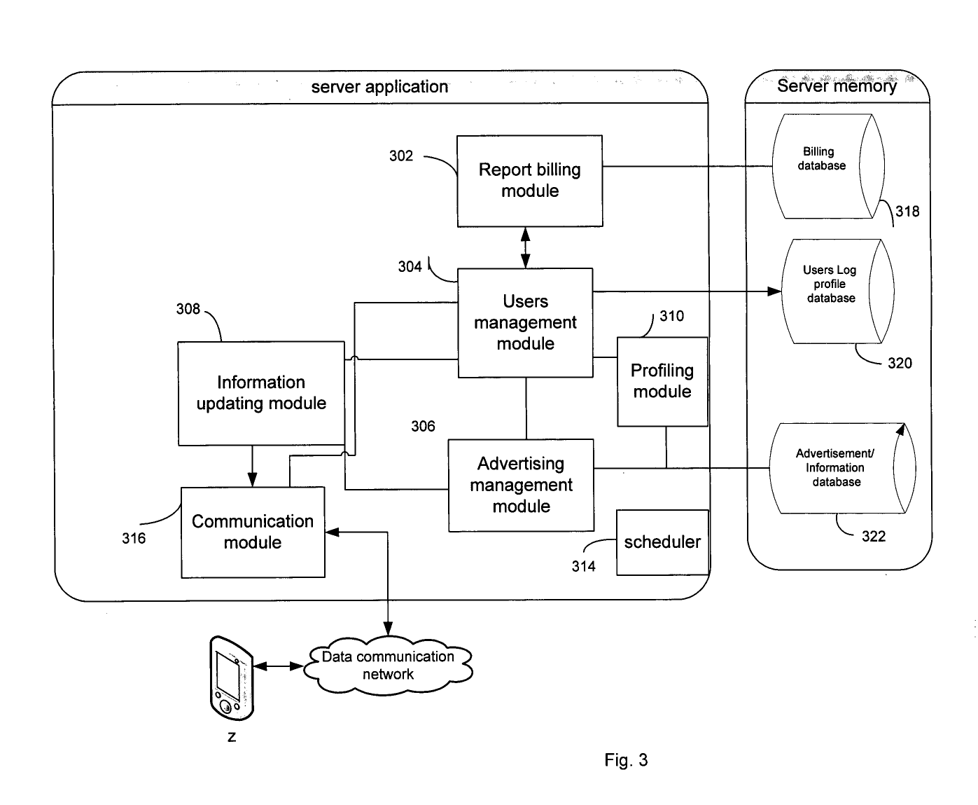

FIG. 3 illustrates a block diagram of the main components of the server application according to some embodiments of the present invention. Users management module 304 updates all user profiles, enable to add or delete users connected to the service. Through the subscription procedure the user provides personal information for creating commercial rules for his application. This information is stored in user profile database 320 and is used for optimal advertisement/marketing content targeting the subscriber's needs and preferences. The user has the flexibility to update this information at any point of time.

The profiling module 310 further updates the user profile according to user logs which include information exposure to commercial information, user related activities and user reaction to the displayed commercial. The user activities logs is further analyzed by the billing report module 302, to create billing report summing up exposure of each advertisement and the actions that the user performed according the advertizing providers or agencies, all billing reports are saved at the billing database 318. The campaign management module 306 receives input of advertisements and advertiser guiding rules and analyzed user behavior pattern for creating business rules for advertisement scheduling and preferences, the campaign information is stored in Advertisement/Information database 322. Based on the business rules the new received commercial information of the advertisement are assigned by the information update module 308, according to updated user profile, creating batch files of information objects for the users. The batch files are downloaded to the mobile devices using the communication modules 316.

The subscriber has the ability, whenever needed, to restrict the display of a specific advertisement/marketing content or company in its mobile device, in addition the subscriber has the ability to disable a specific functionality or the whole system at any period of time

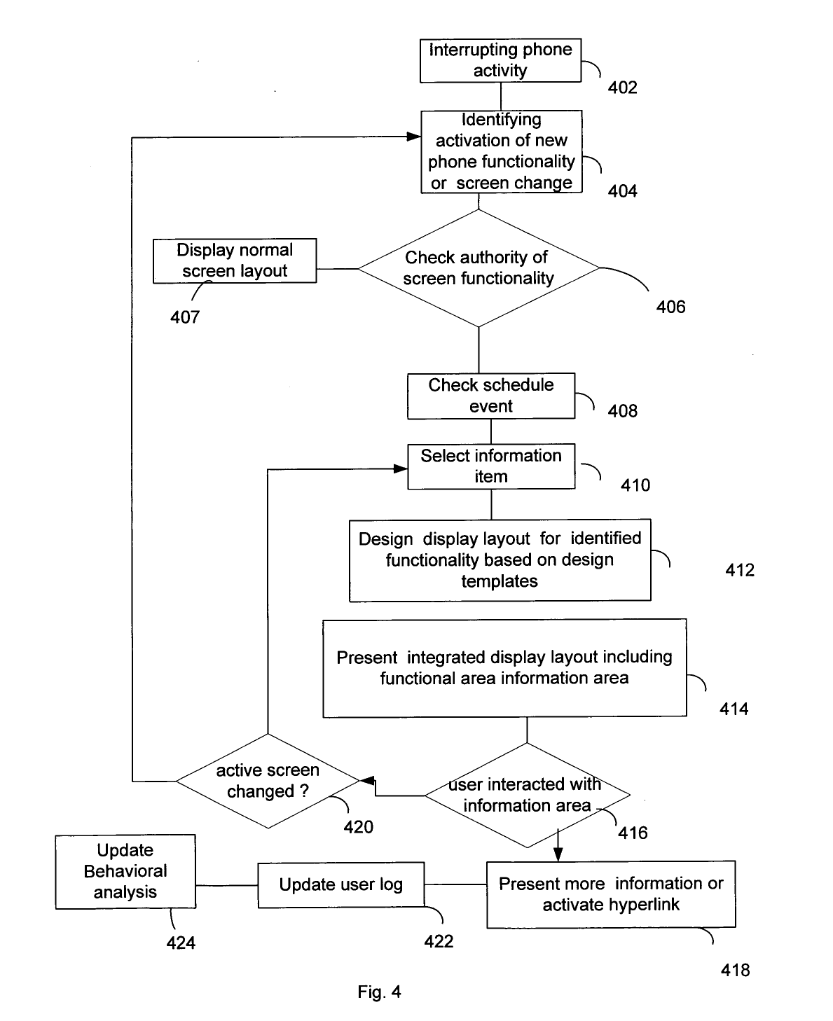

FIG. 4 is flowchart illustrating the process of re-designing and presenting commercial information in accordance with embodiments of the present invention. The detection module continuously monitors mobile device activities, intercepting activation of new phone functionality or screen changes 402. When detecting new activities or screen change 404 which effect the display presentation, the client application checks the authorization 406 assigned to said activity as predefined by the user (or by the phone provider). If authorized, scheduling parameters such time and date are retrieved 408 for selecting new commercial information objects 410 according to predefined business rules, user profile, user log activities and the identified phone functionality. The commercial information objects may be changed during activation of a specific functionality, by identifying texts and context of content to which the user is exposed at both display areas. After the information objects are selected, the respective layout design corresponding to the identified functionally is retrieved 412. The design layout includes at least two areas, one area designated to the original screen of the identified functionality and a second area for commercial information. The design layout template may be changed or adjusted according to schedule input or type of commercial information object. After activating the identified function the user is presented with a single display integrating both areas 414. The user may interact with hyperlink or other interactive button at second area 416, as results the user may receive additional information, activate a service, contact the advertiser or received any other feedback 418. The presentation of new information is maintained within the second display area not interfering with the normal operation of the functional area. The user log is updated 422 at the end of each session of the functional activity, including exposure time and interactive operation. (Optionally tracking user behavior at the functional area such using speaker during conversation). The recorded user log is analyzed 424, detecting user behavioral pattern for updating the campaign business rules accordingly. The detection module continuously checks screen changes or new activities of the device 420, in case of screen changes the process may start again by checking the authority to change the layout of changed screen or optionally in case of small changes select new information object.

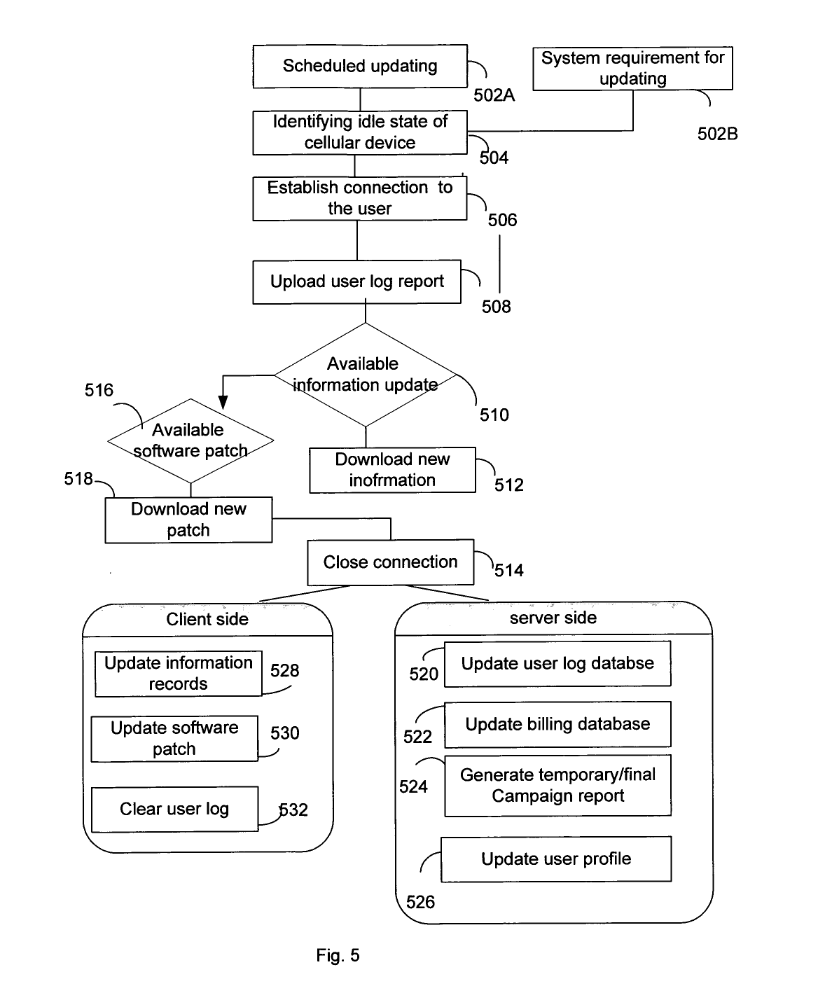

FIG. 5 is flowchart illustrating the process of updating the client and server applications in accordance with additional embodiments of the present invention. The update of the client and the server applications may be initiated according to predefined schedule 502A or per request of the system 502B when identifying priority for updating the commercial information or businesses/campaign rules 502 A and 502 B. Such priority may occur if the campaign success rate is low

The update process is preferably done when the mobile device is in an idle status 504. For starting the update a network connection is established between the server and the client device 506. First, the user recorded log is uploaded to server 508. In case of campaign updates are available 510, the user application downloads new commercial information and related business rules 512. In case a software patch is available 516, it is downloaded to the client device 518. At the end of the uploading and downloading processes, the connection between the server and the client application is closed 514. After the connection is closed the server application stores the uploaded user log at the user log repository 520 and updates the billing repository 522. In addition the server updates the user profile 526 according to analyzed behavioral patterns including responses to commercial content and preferred content. The server further generates and updates a comprehensive campaign report which holds statistics of each campaign and its results 524. At the client side the application saves received campaign information in the advertizing databases 528, updates the new software patch 530 and clear user log 532.

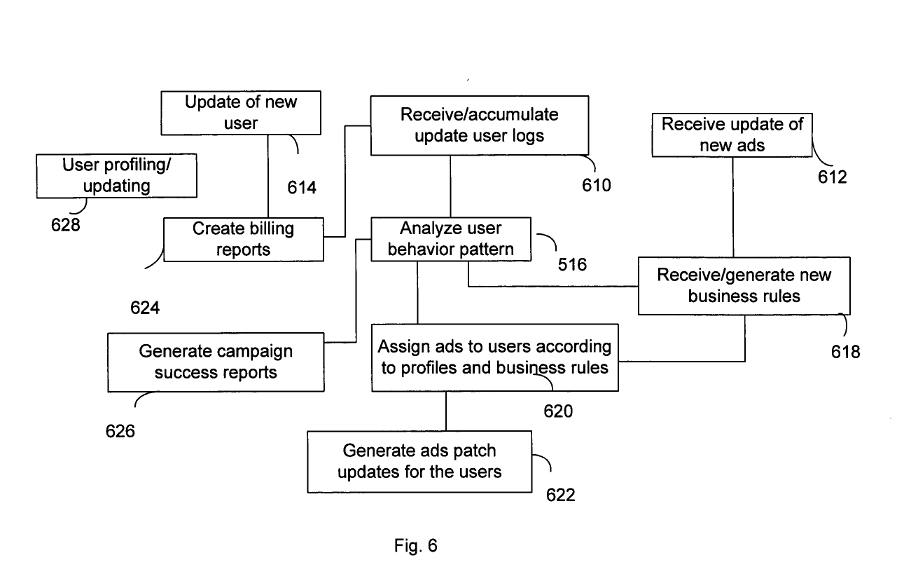

FIG. 6 is a flowchart illustrating the process of the server application in accordance with additional embodiments of the present invention. The server application is updated with all users' logs 610 for updating their profiles and for analyzing behavior pattern 612. The pattern analysis includes the accumulation of all information objects exposure period and user interaction activities for rating the success of the campaigns and updating the business rules. Based on this analysis the commercial information objects are assigned to each user according to his profile.

The server also receives new campaigns of advertisements and business rules 612, based on the new campaign and pattern analysis the business rules are updated 618. The server application prepares patch updates 622 of commercial information including new campaign information according users profile assignment.

FIGS. 7A, 7B and 7C illustrate the change in display layout according to some embodiment of the present invention: the Original mobile display layout 7A, the Original mobile display layout after vertical downsize 7B and the divided display layout including the combination of the commercial area and original functional area. FIGS. 8A, 8B and 8C illustrate the change in display layout according to some embodiment of the present invention: the Original mobile display layout 8A, the Original mobile display layout after horizontal downsize 8B and the divided display layout including the combination of the commercial area and the functional area 8C. FIGS. 9A, 9B and 9C illustrate the change in display layout according to some embodiment of the present invention: the Original mobile display layout 9A, the Original mobile display layout after horizontal and vertical downsize 9B and the divided display layout including the combination of the commercial area (surrounding frame) and original functional area at the center the display 9C.

An embodiment is an example or implementation of the inventions. The various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiments, but not necessarily all embodiments, of the inventions. It is understood that the phraseology and terminology employed herein is not to be construed as limiting and are for descriptive purpose only.

The principles and uses of the teachings of the present invention may be better understood with reference to the accompanying description, figures and examples. It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that the terms “including”, “comprising”, “consisting” and grammatical variants thereof do not preclude the addition of one or more components, features, steps, or integers or groups thereof and that the terms are to be construed as specifying components, features, steps or integers. The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks. The term “method” refers to manners, means, techniques and procedures for accomplishing a given task including, but not limited to, those manners, means, techniques and procedures either known to, or readily developed from known manners, means, techniques and procedures by practitioners of the art to which the invention belongs. The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined. The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A software program application residing on a mobile device for providing and presenting information objects, said application comprises;
a detection module for identifying the activation of at least one function of the mobile device;
a selection module enabling to choose at least one information object upon activation of the mobile device function, according to predefined rules including at least one of the following parameters: a profile of the mobile device user, type of activated functionally, the timing of activation or user preference;
a display management module for designing the display layout to include at least two display areas: a first functional area to display the functional screen of the identified function and the second informative area for displaying pre-defined information which is not required for the activated function, wherein the designing include setting the definitions of each display area, said definitions include at least two parameters: the area size and it's location; and
a GUI module for integrating the display areas into a single presentation, wherein the user is exposed to selected information objects through out the time period he is using the activated functionality;

2. The application of claim 1 wherein the predefined information includes interactive buttons.

3. The application of claim 1 further comprising a scheduler module for determining the next information objects to be displayed according to advertisement campaign business rules.

4. The application of claim 1 further comprising a authorization module for verifying if the identified functionality is approved by the user for changing the its design layout according to user profile definitions.

5. The application of claim 2 wherein the information management module enables to update the information objects and campaign data from a remote server, wherein the update is preformed according pre-defined schedule or rules.

6. The application of claim 2 wherein the information management module enables to record log of exposure periods of each information objects and activation of the interactive buttons, and updating the remote server of said log.

7. The application of claim 6 further comprising an analysis module for analyzing the behavior pattern of the user according to recorded user log.

8. The application of claim 7 further comprising a business rules module for updating the business rules according to user behavior pattern analysis and received updates of the new campaign data.

9. The application of claim 1 wherein the design layout divides the display into two area, wherein the ratio between the areas is determined according to timing, user profile, information objects properties,

10. A method for providing and presenting information object on a mobile device, said method comprises;
identifying the activation of at least one function of the mobile device;
selecting at least one information object upon activation of the phone function, according to predefined rules including at least one of the following parameters: a profile of the mobile device user, type of activated functionally, the timing of activation or user preference;
designing the mobile display layout to include at least two display areas: a first functional area to display functional screen of the identified function and the second informative area for displaying pre-defined information which is not required for the activated function, wherein the designing include setting the definitions of each display area, said definitions include at least two parameters the area size and it's location;
integrating the display areas into a single presentation, wherein the user is exposed to selected information object through out the time period he is using the activated functionality;
wherein at least one of the following: identifying, selecting, designing and integrating is performed by at least one processing unit

11. The method of claim 10 further comprising the step of updating the information objects by downloading new objects from a remote server through wireless data network, wherein the update is preformed according pre-defined schedule or rules.

12. The method of claim 10 further comprising the step of recording user log of his exposure to the information and activities, said log is periodically updated at a remote server through wireless data network.

13. The method of claim 12 further comprising the step of analyzing behavior pattern of the user based on recorded log.

14. The method of claim 10 further comprising the step of scheduling the next information objects to be displayed according to advertisement business/campaign management rules.

15. The method of claim 10 further comprising the step of verifying if the identified functionality is approved by the user for changing the its design layout according to user profile definitions.

16. The method of claim 10 further comprising the step of changing selected information objects during the activation of a specific functionality, in accordance with identified texts and context of content to which the user is exposed at both display areas.

17. The method of claim 13 further comprising the step of updating the business rules according to user behavior pattern analysis and received updates of the new campaign data.

18. The method of claim 10 wherein the design layout divides the display into two areas, wherein the ratio between the areas is determined according to timing, user profile or information object properties.

19. A system for distributing and presenting commercial information on a mobile device, said system comprised of:
a server application including campaign management module enabling to define business rules, and user management module;
a client application including, detection module for identifying new activated function of mobile device, selection module for choosing at least one commercial objects and layout design module for designing display layout including at least two areas: functional area and commercial information area, and a tracking module for measuring the exposure of the user to selected information objects
wherein the server application updates the device with new campaign information and client application updates the server with user log including exposure time of the commercial information;
wherein the selections of commercial objects and the campaign information business rules are determined according pattern analysis of the users' logs.
